(19) United States
(12) Patent Application Publication
(10) Pub. No.: US 2005/0025562 A1
(43) Pub. Date: Feb. 3, 2005

(54) Document binder

(76) Inventor: Shlomo Ben-Shoham, Jerusalem (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/630,914

(22) Filed: Jul. 31, 2003

(51) Int. Cl. B42F 3/00

(52) U.S. Cl. 402/5

(57) ABSTRACT

A document binder includes two side covers pivotally attached to opposing edges of a back cover, wherein on the internal face of each side cover at least one rigid peg is pivotally attached. Each peg is located in a corresponding position for inter-engagement with a matching peg of the opposite side cover. The total length of each pair of inter-engaged pegs varies in use in accordance with the opening angle of the side covers.

### FIELD OF THE INVENTION

The present invention relates to a document binder having document fastener which its length varies during use according to the opening angle of the binder's side covers, allowing for a convenient browsing and for fast and easy filing and removing documents.

### BACKGROUND OF THE INVENTION

The need for reliable binding methods is ever present and growing in the modern world, whore almost every human being is faced with the need to file all kinds of documents for future reference. There are several known methods for document filing in binders. One known method for document binding is to bind the documents permanently, in the form of a book, using an adhesive strip which is glued to the side of a bunch of paper sheets, thus holding these papers together. This method is good for papers of substantially equal dimensions, and is useless if a certain document needs separation from the entire bunch. For convenient separation of documents another method of binding is used. Each sheet of paper is perforated at the same relative location on the sheet, and is threaded on a peg, which is attached to a folder, thus holding said sheet of paper in place. Commonly documents destined to be filed in binders are perforated in at least two (usually exactly two) locations, near one of the elongated edges of the paper.

Several types of such pegs are known. One type of such a peg is a foldable peg which when erect allows for the filing or removing of documents, and when folded sideways prevents the release of the bound documents. Optionally an additional bar is placed onto the folded peg to obstruct erecting it unintentionally. Using this binding method insures relatively secure binding, but is extremely inconvenient when a certain document needs to be released and taken out of the binder.

There is the semi-circular peg, which can be drawn to an adjacent semicircular such peg, forming a ring, thus preventing the release of the filed documents, in one position. To take up its other position the semi-circular peg can be drawn away form the adjacent peg, thus opening the ring and allowing for the removal of filed documents or filing of additional documents. Generally the semi-circular peg is held in its open or closed position by means of a spring. A major drawback of the semicircular peg binding is the tendency of the peg to give way and become slack in its closed position, thus allowing slipping of sheets out of the ring, and their subsequent detachment from the binder.

It is the object of the present invention to provide a novel document binding mechanism, which provides reliable and secure binding, and at the same time allows quick and easy removal or separation of required documents from the binder.

Yet another object of the present invention is to provide a document binding mechanism that allows for relatively large number of documents to be securely filed.

### BRIEF DESCRIPTION OF THE INVENTION

The present invention relates to a document binder comprising two side covers, pivotally attached to opposing edges of a back cover, wherein on the internal face of each side cover at least one rigid peg is pivotally attached, and each peg is located in a corresponding position for an inter engagement with a mate peg of the opposite side cover, such that the total length of each pair of inter engaged pegs is varying during use according to the opening angle of the side covers.

### BRIEF DESCRIPTION OF THE FIGURES

FIG. 1 Illustrates the ‘engaged’ position of a preferred embodiment of the mechanism for a document binder of the present invention, where the binder is partially opened on both side covers.

FIG. 2 Illustrates the ‘engaged’ position of said preferred embodiment of the mechanism for a document binder of the present invention, where the binder is partially opened on one side cover and fully opened on the other side cover.

FIG. 3 Illustrates the ‘engaged’ position of said preferred embodiment of the mechanism for a document binder of the present invention, where the binder is closed on both side covers.

FIG. 4 Illustrates the ‘engaged’ position of said preferred embodiment of the mechanism for a document binder of the present invention, where the binder is partially opened on one side cover and closed on the other side cover.

FIG. 5 Illustrates the ‘disengaged’ position of a preferred embodiment of the mechanism for a document binder of the present invention, where the binder is fully opened on both side covers, allowing the disengagement of the pegs for removal or insertion of documents.

FIG. 6 Illustrates a top view of the ‘disengaged’ position of said preferred embodiment of the mechanism for a document binder of the present invention, where the binder is fully opened on both side covers, allowing the disengagement of the pegs and removal or insertion of documents.

FIG. 7 Illustrates the disengaged position with the pegs in a vertical orientation (open position), allowing filing or removal of documents.

FIG. 8 Illustrates a disengaged position of another variation of the document binder according to the present invention. According to this variation, the side covers has to be drawn apart in angles of more then 180 degrees for reaching the “disengaged” position.

FIG. 9 Illustrates a mechanism for providing steady definite positions to the pegs, with a disengaged peg lying steadily due to the appropriate relative position between protrusions and a leaf-spring of the mechanism.

FIG. 10 Illustrates the leaf-spring and protrusions of the same mechanism of FIG. 9, with the peg in a vertical orientation (open position).

### DETAILED DESCRIPTION OF THE INVENTION AND FIGURES

The mechanism for a document binder of the present invention seeks to provide a simple and convenient filing and removing of documents in and out of a document folder.

FIG. 1 illustrates the ‘engaged’ position of a preferred embodiment of the mechanism for a document binder of the present invention, where the binder is partially opened on both side covers.

The binder consists of a folder (1) having two opposing side covers (2), which are pivotally attached to a common rigid rectangular back cover (3), at opposing edges. A pair of rigid pegs (4, 5) is employed, each peg being attached pivotally to a side cover at a corresponding position opposite the peg of the other side cover. According to the present embodiment, the pivoting ability is achieved by connection the peg to the cover through clasps (6). The total length of both pegs is greater than the back cover (3) width across its surface This is imperative in order to enable engagement of these pegs by insertion of one peg inside the other. In this embodiment one peg (4) of the pair is hollow along its stem allowing the other peg (5) to be telescopically inserted inside the hollow cavity of the first peg. The insertion of one peg into the other can take place when the opposing side covers (2a) of the folder are drawn closer. The bound documents are threaded onto said pegs. In comparison with pegs of known document binders, the stem of the pegs according to the present invention is curved in a relatively flat arc. In addition, in an open position of the binder the pegs are extended telescopically up to twice of their length of close position (in known binders the length of the pegs is fixed). Due to the flat are and the space obtained between documents in the extended position of the pegs, the documents can be turned conveniently, similarly to turning pages of book. It should be noted, however, that other methods of engagement between the pegs could be employed. For instance, one peg can be designed to have an external groove into which the other peg can fit and slide along. In the context of the present invention a pair of pegs which are adapted for sliding along each other are called also “mate pegs”; a single peg from mate pegs is called also “mate peg”.

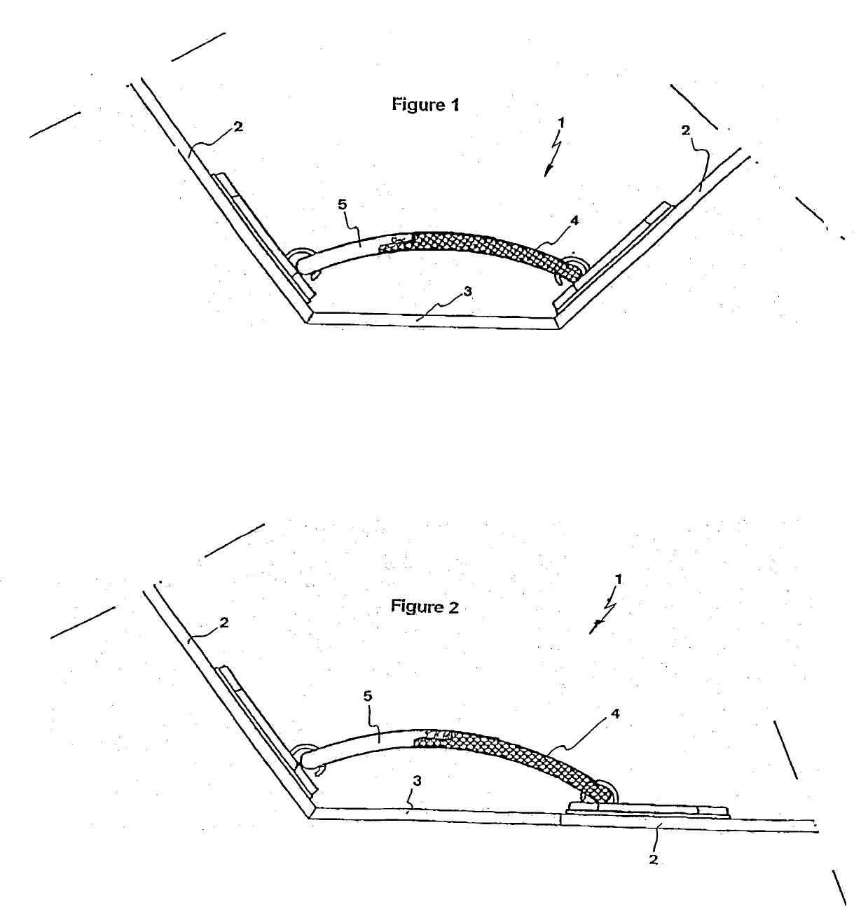

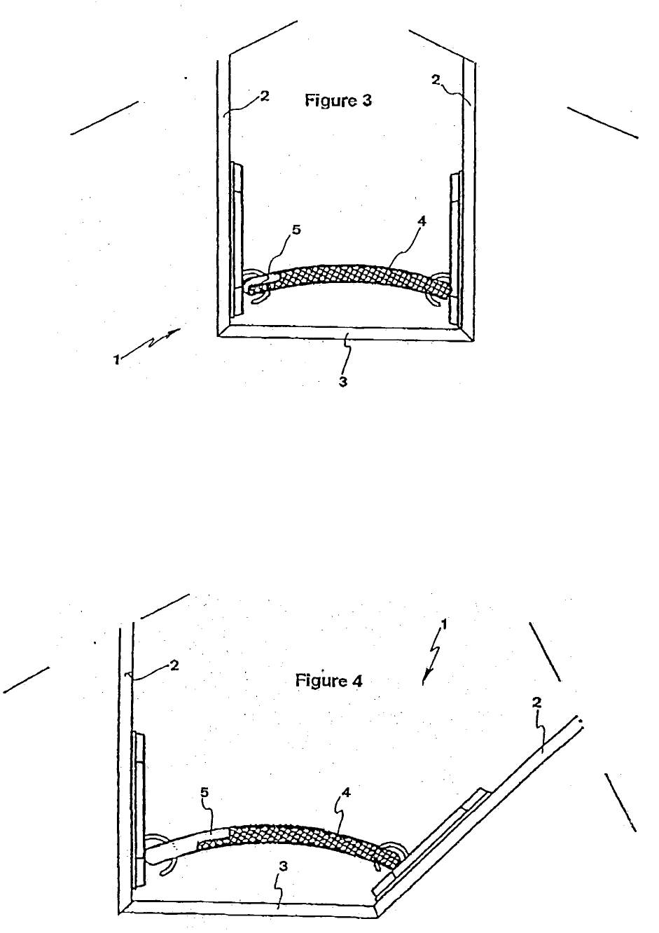

FIGS. 2-4 illustrate various relative peg positions respectful of the side covers position, all while maintaining the “engaged” position.

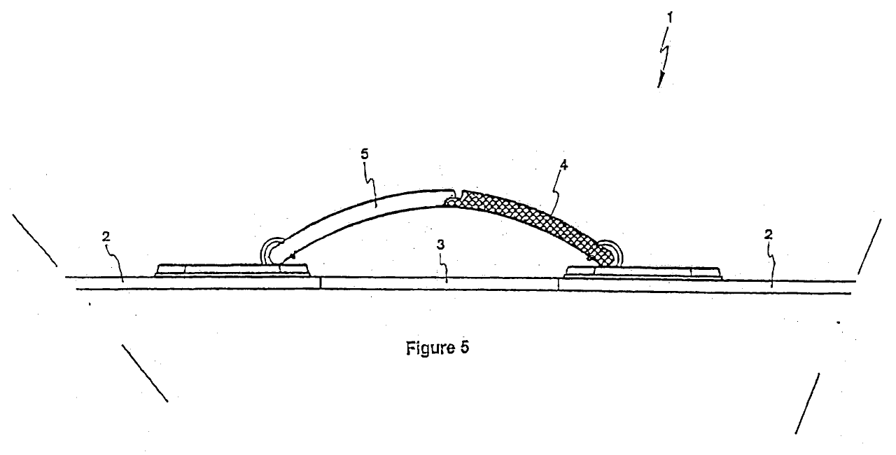

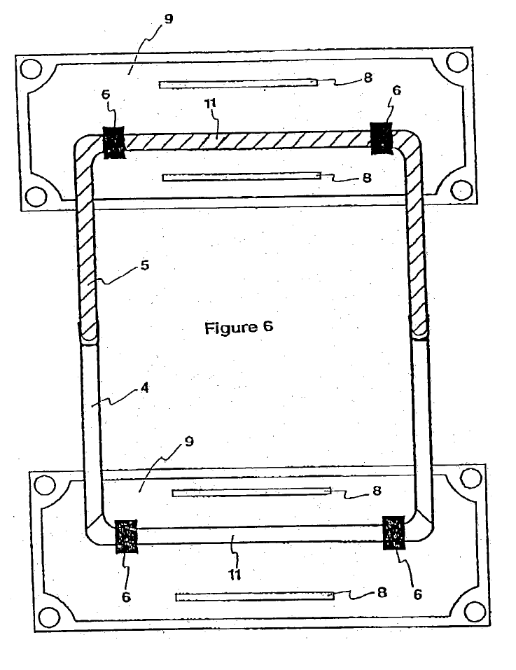

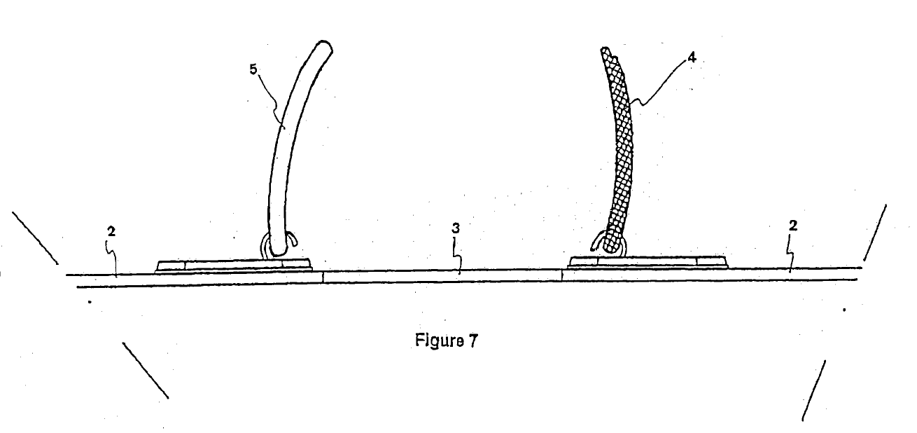

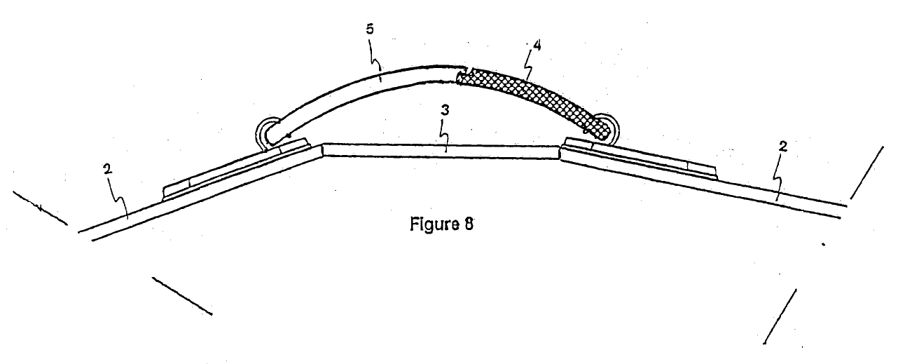

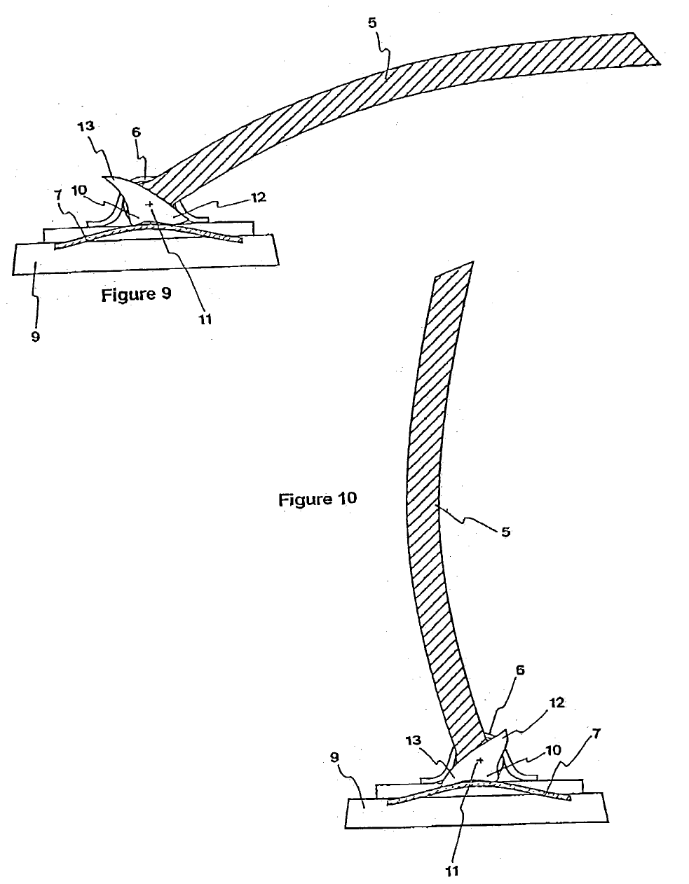

Reference is now made to FIG. 5 illustrates the ‘disengaged’ position of a preferred embodiment of the mechanism for a document binder of the present invention, where the binder is fully opened on both side covers, allowing the disengagement of the pegs and removal or insertion of documents.

The pegs can be disengaged when the side covers (2) are fully drawn apart, when the inserted peg is pulled out of the other peg. After the pegs are disengaged, the pegs of each side can be separately pivot to a vertical position, allowing a convenient removal or filing of documents. Preferably, the pivoting mechanism of pegs includes a spring (preferably a leaf spring). The leaf spring (7) is connected and located between two slits (8) in a metal plate (9), and this metal plate is attached to the side cover of the binder. The leaf spring (7) enables a pressed passage of an excentral protrusion (10) form the axis (11) around which pivots the peg within the clasp (6). The pivot axis (11) is adjacent to the leaf spring (7), and the protrusions (10) (12) (13) are arranged such that the leaf spring resists the movement of the axis between an “open” position (when the peg is oriented substantially vertically to its attached side cover) and a “disengagement” position (when the facing pegs are just disengaged, but still lying parallel to the back cover). The protrusions (12) (13) form both sides of the protrusion (10), prevent the peg form deviation into unwanted positions. (The same effect may achieved alternatively with a leaf spring which passes from above the axis (11), or in other ways as well). Thus, by means of the mutual relations between the leaf spring and the protrusions (10) (12) (13), the momentary “open” and “disengagement” positions of the disengaged pegs are kept steadily.

In this position documents can be filed inside the binder, or removed from it conveniently. FIG. 6 illustrates a top view of the ‘disengaged’ position of said preferred embodiment of the mechanism for a document binder of the present invention, where the binder is fully opened on both side covers, allowing the disengagement of the pegs and removal or insertion of documents. In this embodiment two pairs of pegs are used, and this arrangement suits punched documents with a pair of matching holes.

Preferably at least two pairs of pegs are employed in the mechanism for a document binder of the present invention, in order to provide firm grip of the documents and avoid movements of these documents inside the binder. However more than two pairs of pegs call also be used. It should be noted that the number of peg pairs ought to match the number of perforations in the documents to be filed.

Standard perforation of documents using office punch produces circular holes 5 mm in diameter, and therefore it is recommended that the pegs have a circular cross section, as illustrated in FIG. 3. The hollow peg's outside diameter ought to be smaller than 5 mm, whereas the other peg's outside diameter should be smaller than the inside diameter of the hollow peg.

The disclosed mechanism of the present invention is also applicable in a binder with detachable side-covets, which are secured to the back cover with screws or other means.

The binder mechanism of the present invention allows smaller binder dimensions than the prior art binders.

It should be clear that the description of the embodiments and attached Figures set forth in this specification serves only for a better understanding of the invention, without limiting its scope as covered by the following claims.

It should also be clear that a person in the art, after reading the present specification could make adjustments or amendments to the attached Figures and above described embodiments that would still be covered by the following claims.

1. A document binder, comprising:
a back cover:
left and right side covers pivotally attached to opposing edges of said back cover;
at least one pair of pegs, each of said peas being pivotally attached to an inner face of one of said side covers; and
wherein the peg pivotally attached to the left side cover is located in a corresponding position for engagement with the peg pivotally attached to the right side cover, such that a total length of said pegs being engaged is varying during use according to an opening angle of the side covers.

2. The binder according to claim 1, wherein each of said pegs is rotatable from an engagement position, where said peg is engaged with the other peg, to an open position where said peg is oriented substantially vertically to the respective side cover to which said peg is pivotally attached.

3. The binder according to claim 2, further comprising means for keeping each of said pegs steadily in the open position.

4. The binder according to claim 1, wherein
a first one of said pegs has a hollow cavity and a second one of said pegs can be telescopically inserted inside the hollow cavity of said first peg, when the side covers are drawn closer; and
said second peg can be withdrawn from said first peg by pulling said pegs apart when said side covers are drawn apart.

5. The binder according to claim 1, comprising two of said at least one pair of pegs.

6. The binder according to claim 1, comprising more than two of said at least one pair of pegs.

7. The binder according to claim 1, wherein the pegs have a circular cross section.

8. The binder according to claim 7, wherein one of said pegs is hollow and the other peg has an outside diameter which is smaller than an inside diameter of the hollow peg.

9. The binder according to claim 1, wherein one of said pegs is hollow and said hollow peg has an outside diameter which is smaller than 5 mm.

10. (canceled)

11. A document binder, comprising:
first and second side covers pivotally attached to each other; and
at least one pair of pegs including a first peg pivotally attached to said first side cover and a second peg attached to said second side cover;
wherein the first peg is engageable with the second peg, and, when said first and second pegs are engaged, said first and second pegs remain slidable along each other as the first and second side covers are rotated relative to each other.

12. The binder according to claim 11, wherein said first peg is rotatable, relative to said first side cover, between an engagement position, where said first peg is engageable with the second peg, and an open position, where said first peg is disengaged from the second peg.

13. The binder according to claim 12, further comprising a spring biasing said first peg away from the engagement position when said first peg is in the open position.

14. The binder according to claim 13, wherein said spring further biases said first peg away from the open position when said first peg is in the engagement position.

15. The binder according to claim 11, wherein one of said first and second pegs has an external groove in which the other of said first and second pegs is at least partially and slidably inserted when said first and second pegs are engaged.

16. The binder according to claim 11, wherein one of said first and second pegs has a hollow cavity in which the other of said first and second pegs is at least partially received when said first and second pegs are engaged.

17. The binder according to claim 11, wherein said second peg is pivotally attached to the second side covers;
said first and second pegs will be engaged from a disengaged state when the first and second pegs are rotated, relative to the first and second side covers, respectively, toward each other to assume an engagement position, and then the first and second side covers are rotated toward each other; and
said first and second pegs will be disengaged from an engaged state when the first and second side covers are rotated away from each other, and then the first and second pegs are rotated, relative to the first and second side covers, respectively, away from each other to assume an open position.

18. The binder according to claim 11, wherein, when said first and second pegs are engaged, said first and second pegs can be disengaged only after said first and second side covers have been rotated away from each other by more than 180 degrees.

19. The binder according to claim 11, further comprising first and second U-shaped members each having a middle portion and two legs extending from opposite ends of said middle portion, wherein
the middle portions of said first and second U-shaped members are pivotally attached to the first and second side covers, respectively;
one of the legs of the first U-shaped member defines the first peg, while the other of the legs of the first U-shaped member defines a third peg;
one of the legs of the second U-shaped member defines the second peg, while the other of the legs of the second U-shaped member defines a fourth peg engageable with the third peg of the first U-shaped member.

20. The binder according to claim 19, further comprising
at least first and second clasps rotatably retaining the middle portions of said first and second U-shaped members, respectively, on the first and second side covers, respectively; and
a back cover to opposite sides thereof said first and second side covers are pivotally attached.
